(19) United States
(12) Patent Application Publication
(10) Pub. No.: US 2014/0019139 A1
(43) Pub. Date: Jan. 16, 2014

(54) BLOOD GLUCOSE METER WITH SIMPLIFIED PROGRAMMABLE VOICE FUNCTION

(71) Applicants: Ramzi ABULHAJ, Charlotte, NC (US); Moo Nam KO, Charlotte, NC (US); William BAXTER, Holly, MI (US); Amr Yehia Mohamed SHEHAB, Charlotte, NC (US)

(72) Inventors: Ramzi ABULHAJ, Charlotte, NC (US); Moo Nam KO, Charlotte, NC (US); William BAXTER, Holly, MI (US); Amr Yehia Mohamed SHEHAB, Charlotte, NC (US)

(73) Assignee: PRODIGY DIABETES CARE, LLC, Charlotte, NC (US)

(21) Appl. No.: 13/547,400

(22) Filed: Jul. 12, 2012

(51) Int. Cl. G10L 21/00

(52) U.S. Cl. 704/270; 704/E21.001

(57) ABSTRACT

A blood glucose meter with a simplified programmable voice function, including: a microprocessor; a memory that is both programmable and re-programmable coupled to the microprocessor; and an audio output device coupled to the microprocessor and the memory; wherein a language algorithm and a plurality of language components specific to a language selected by a user are disposed within the memory; and wherein the language algorithm and the plurality of language components are utilized to provide an audio output through the audio output device in the language selected by the user. The language algorithm is operable for determining which language components are utilized to provide the audio output and in what order based on the language selected by the user. Optionally, the audio output is generated by the microprocessor and the memory using a pulse-width modulation scheme and/or the like.

### FIELD OF THE INVENTION

The present invention relates generally to a blood glucose meter with a simplified programmable voice function. More specifically, the present invention relates to a blood glucose meter with a simplified programmable voice function that does not utilize an excessive and expensive voice chip (i.e. a microprocessor package with a large amount of memory and preprogrammed data representing voice files and/or a voice driver, for example).

### BACKGROUND OF THE INVENTION

Unfortunately, diabetes has become a common chronic ailment in the United States and around the World. When insulin in the blood is insufficient, glucose cannot efficiently be converted into energy. The resulting surplus glucose leads to apoplexy and other serious diseases. Thus, a diabetic, even on an insulin treatment regime, must frequently monitor his or her blood glucose level. This is often done using an electronic meter, test strips, and lancets that are used to “prick” a fingertip, such that a blood sample can be collected. Given the fact that many diabetics are older and/or suffer from some degree of visual impairment, electronic meters featuring “voice” or “talking” interfaces and readouts in a variety of languages have become very popular and are widely sold.

Typical blood glucose meters having a programmable voice function include a voice chip and/or read-only memory (ROM) on which voice files and/or voice drivers associated with one or more languages are preloaded at the time of manufacture or shipping. For example, such a blood glucose meter may have a voice chip and/or ROM that is programmed to deliver directions and/or results in one or more of English, Spanish, French, German, and/or Arabic, as selected by a user, with a typical blood glucose meter “containing” three or four language options when shipped. With Worldwide sales of diabetes products, this makes it necessary for a supplier to maintain inventories of different blood glucose meters with different voice chips, which is inefficient and expensive. In addition, these voice chips are expensive and typically include unnecessarily large amounts of memory, most of which is unused in the blood glucose meter applications.

Various attempts have been made to address the above-referenced issues. For example, U.S. Patent Application Publication No. 2011/0034794 (Chen, U.S. patent application Ser. No. 12/854,903, filed Aug. 12, 2010, published Feb. 10, 2011) provides a blood glucose meter with an independent voice integrated circuit (IC) supporting post-production adjustment of the voice function. The blood glucose meter is allowed to work with a replaceable voice carrier so as to provide voice services in different languages that help users to correctly and easily operate the blood glucose meter. The blood glucose meter features that the voice carrier is not built in the blood glucose meter during production of the blood glucose meter. Instead, a driving module is edited in an IC chip of the blood glucose meter. When an actual ordered amount is confirmed, the different voice carriers can be assembled to a voice IC expansion port of the blood glucose meter, thereby reducing manufacturing and inventory costs for the blood glucose meter. The primary objective is to provide the blood glucose meter with the independent voice IC, which is constructed by assembling two semi-finished products, namely a blood glucose meter and a voice carrier, so as to eliminate the need of maintaining stocks of blood glucose meters with many different-language voice ICs, and to eliminate the need of re-editing voice files and voice drivers of different languages. As long as there are blood glucose meters and voice carriers for different languages in stock, the two parts can be assembled according to a received order, thereby reducing the inventory control costs. The secondary objective is to provide the blood glucose meter with the independent voice IC, wherein when an order is put in for the blood glucose meter with the voice IC operating in a certain language, the production line can produce only the part out of stock, such as the voice carrier, and then assemble it with the part in stock, such as the blood glucose meter, so as to prompt timely shipment of products catering to market demands.

Such attempts, however, have done nothing to eliminate the need for expensive voice chips with unnecessarily large amounts of unused memory. Thus, what is still needed in the art is a blood glucose meter with a simplified programmable voice function that does not utilize an excessive and expensive voice chip.

### BRIEF SUMMARY OF THE INVENTION

In various exemplary embodiments, the present invention provides a blood glucose meter with a simplified programmable voice function that does not utilize an excessive and expensive voice chip. This blood glucose meter includes a programmable, and preferably re-programmable, internal or insertable memory (such as flash memory) in which voice data (i.e. language files and/or language drivers) related to one or more languages are selectively stored by a manufacturer and/or a user. Preferably, this voice data is downloaded in a wired or wireless manner via a computer (e.g. using the Internet) from a language module repository (e.g. a website and language server). Thus, the manufacturer may keep only un-programmed blood glucose meters, or blood glucose meters pre-programmed with one specific language, in inventory, and then program or re-program them with an ordered language prior to shipment, or simply allow the user to program or re-program them after purchase via a home computer, universal serial bus (USB) cable or wireless link, and the Internet, for example.

In one exemplary embodiment, the present invention provides a blood glucose meter with a simplified programmable voice function, including: a microprocessor; a memory that is both programmable and re-programmable coupled to the microprocessor; and an audio output device coupled to the microprocessor and the memory; wherein a language algorithm and a plurality of language components specific to a language selected by a user are disposed within the memory; and wherein the language algorithm and the plurality of language components are utilized to provide an audio output through the audio output device in the language selected by the user. Preferably, the memory is a flash memory. Preferably, the audio output device is a speaker. The language algorithm is operable for determining which language components are utilized to provide the audio output and in what order based on the language selected by the user. The plurality of language components include a plurality of phrases, words, letters, and/or numbers in the language selected by the user. Preferably, the audio output is generated by the microprocessor and the memory using a pulse-width modulation scheme and/or the like. Preferably, the language algorithm and the plurality of language components are disposed within the memory via download from a language server. Optionally, the language algorithm and the plurality of language components are disposed within the memory via download from a language server via a website and one of a universal serial bus port and a wireless link.

In another exemplary embodiment, the present invention provides a method for providing a blood glucose meter with a simplified programmable voice function, including: providing a microprocessor; providing a memory that is both programmable and re-programmable coupled to the microprocessor; and providing an audio output device coupled to the microprocessor and the memory; wherein a language algorithm and a plurality of language components specific to a language selected by a user are disposed within the memory; and wherein the language algorithm and the plurality of language components are utilized to provide an audio output through the audio output device in the language selected by the user. Preferably, the memory is a flash memory. Preferably, the audio output device is a speaker. The language algorithm is operable for determining which language components are utilized to provide the audio output and in what order based on the language selected by the user. The plurality of language components include a plurality of phrases, words, letters, and/or numbers in the language selected by the user. Preferably, the audio output is generated by the microprocessor and the memory using a pulse-width modulation scheme and/or the like. Preferably, the language algorithm and the plurality of language components are disposed within the memory via download from a language server. Optionally, the language algorithm and the plurality of language components are disposed within the memory via download from a language server via a website and one of a universal serial bus port and a wireless link.

In a further exemplary embodiment, the present invention provides a method for providing a blood glucose meter with a simplified programmable voice function, including: providing a microprocessor; providing a memory that is both programmable and re-programmable coupled to the microprocessor; and providing an audio output device coupled to the microprocessor and the memory; wherein a language algorithm and a plurality of language components specific to a language selected by a user are disposed within the memory; wherein the language algorithm and the plurality of language components are utilized to provide an audio output through the audio output device in the language selected by the user; and wherein the language algorithm and the plurality of language components are disposed within the memory via download from a language server. Preferably, the memory is a flash memory. The language algorithm is operable for determining which language components are utilized to provide the audio output and in what order based on the language selected by the user. The plurality of language components include a plurality of phrases, words, letters, and/or numbers in the language selected by the user. Preferably, the audio output is generated by the microprocessor and the memory using a pulse-width modulation scheme and/or the like. Optionally, the language algorithm and the plurality of language components are disposed within the memory via download from a language server via a website and one of a universal serial bus port and a wireless link.

### BRIEF DESCRIPTION OF THE DRAWINGS

The present invention is illustrated and described herein with reference to the various drawings, in which like reference numbers are used to denote like device components/method steps, as appropriate, and in which:

FIG. 1 is a schematic diagram illustrating one exemplary embodiment of the blood glucose meter with a simplified programmable voice function of the present invention;

FIG. 2 is a schematic diagram illustrating one exemplary embodiment of the language function associated with the blood glucose meter with a simplified programmable voice function of the present invention; and

FIG. 3 is schematic diagram illustrating one exemplary embodiment of the language programming system associated with the blood glucose meter with a simplified programmable voice function of the present invention.

### DETAILED DESCRIPTION OF THE INVENTION

Again, in various exemplary embodiments, the present invention provides a blood glucose meter with a simplified programmable voice function that does not utilize an excessive and expensive voice chip. This blood glucose meter includes a programmable, and preferably re-programmable, internal or insertable memory (such as flash memory) in which voice data (i.e. language files and/or language drivers) related to one or more languages are selectively stored by a manufacturer and/or a user. Preferably, this voice data is downloaded in a wired or wireless manner via a computer (e.g. using the Internet) from a language module repository (e.g. a website and language server). Thus, the manufacturer may keep only un-programmed blood glucose meters, or blood glucose meters pre-programmed with one specific language, in inventory, and then program or re-program them with an ordered language prior to shipment, or simply allow the user to program or re-program them after purchase via a home computer, USB cable or wireless link, and the Internet, for example.

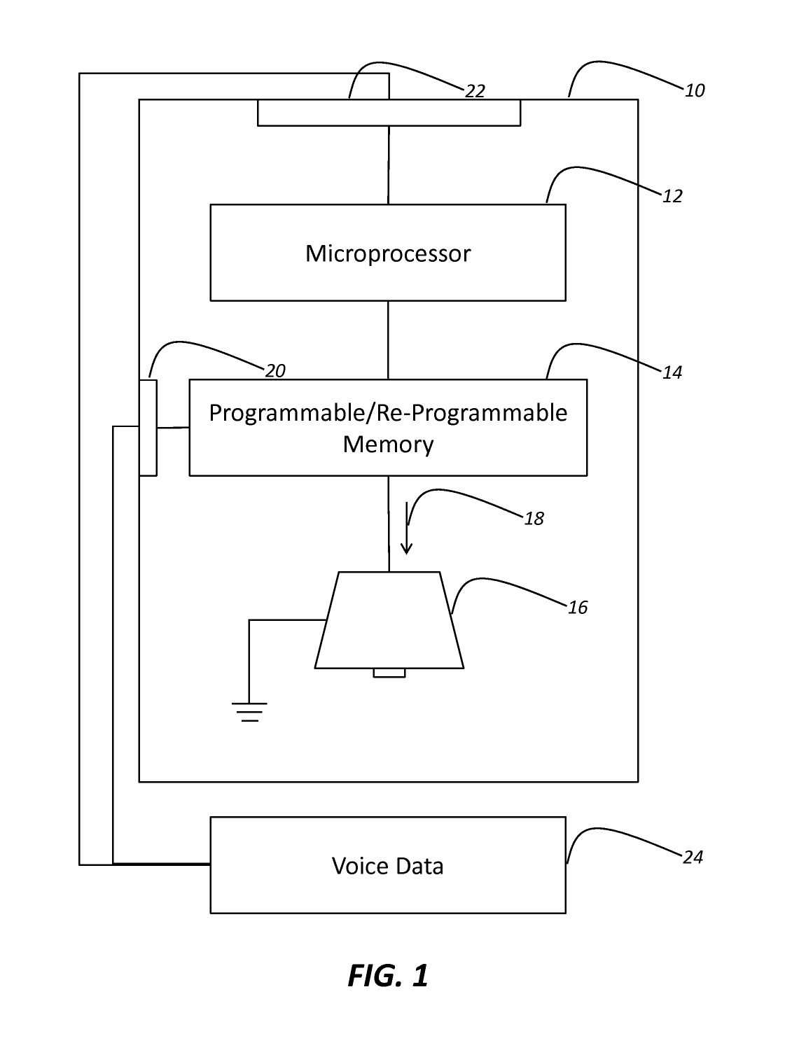

Referring now specifically to FIG. 1, in one exemplary embodiment, the blood glucose meter 10 of the present invention includes a microprocessor 12 operable for controlling the conventional functions of the blood glucose meter 10, such as calibrating the blood glucose meter 10, receiving a blood sample disposed on a test strip, processing the blood sample, testing the blood sample, providing a corresponding output, and processing and/or storing the results, for example. In this regard, the blood glucose meter 10 can also include a plurality of conventional components, such as test strip-receiving hardware, an input interface/display, an output interface/display, a power supply, appropriate software operating on the microprocessor 12, etc. The blood glucose meter 10 further includes a programmable/re-programmable memory 14, such as a flash memory or the like, in which voice data 24 is selectively stored. This voice data 24 includes any and all data that enables the blood glucose meter 10 to effectively convey information in a given language, and can include a list of phrases, words, letters, and/or numbers and an algorithm that allows these phrases, words, letters, and/or numbers to be assembled responsive to the actions of the microprocessor 12 in accordance with the conventions of the given language. The programmable/re-programmable memory 14 is coupled to a speaker 16 or other audio output device through which the information is conveyed using a pulse-width modulation (PWM) scheme 18 and/or the like, by which digital information is converted to analog information, instead of analog information being converted to digital information, as is conventional—thereby providing an audio output. In this manner, the conveyed information is “generated” or “played back” as facilitated by the programmable/re-programmable memory 14, as opposed to a voice chip or the like. The PWM scheme 18 is well known to those of ordinary skill in the art, although it has not been utilized in a blood glucose meter application previously. The programmable/re-programmable memory 14 is programmed/re-programmed by a manufacturer/user via a USB port 20 and/or an antenna/wireless interface 22 and a communicatively-coupled website or computer network coupled to or including a language server on which the voice data 24 is stored. The manufacturer/user simply goes to the website or computer network, selects the language voice data 24 to be downloaded, and downloads it to the programmable/re-programmable memory 14. Optionally, blood glucose meter calibration and operation data can be downloaded in a similar manner to the programmable/re-programmable memory 14. It will be readily apparent to those of ordinary skill in the art that the “talking” blood glucose meter 10 of the present invention can include additional/alternative conventional components, as desirable, although such components are not illustrated and/or described in detail here for the sake of brevity and so as not to obscure the novel aspects of the present invention.

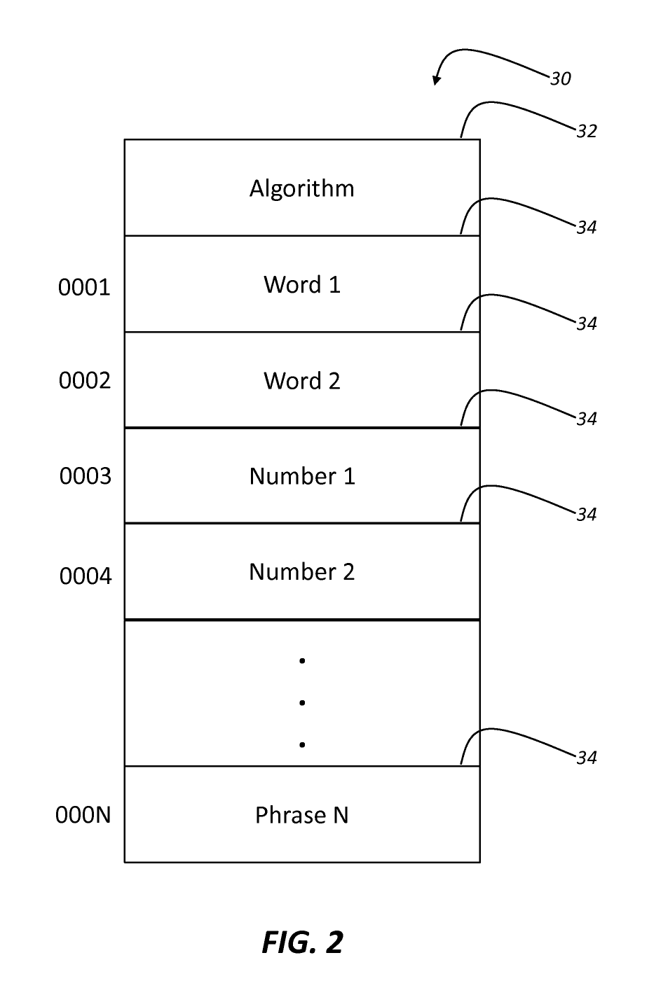

Referring now specifically to FIG. 2, in one exemplary embodiment, the language function 30 of the present invention includes a language algorithm 32 and a plurality of language components 34, such as a plurality of phrases, words, letters, and/or numbers in a given language. These language components 34 represent the typical required elements of the audio output of the blood glucose meter 10 (FIG. 1) in the given language. Essentially the same software is programmed into the blood glucose meter 10 for each given language, but the plurality of language components 34 can be different and/or arranged in a different manner and/or order depending upon the given language at the direction of the language algorithm 32, which is specific to the given language selectively programmed into the programmable/re-programmable memory 14 (FIG. 1). For example, numbers are assembled from digits differently in English than they are in Arabic. This is accounted for in one or both of the language components 34 and the language algorithm 32 selectively programmed into the programmable/re-programmable memory 14. The result, in any event, is an intelligible audio output conveying relevant information in the language of choice of the user.

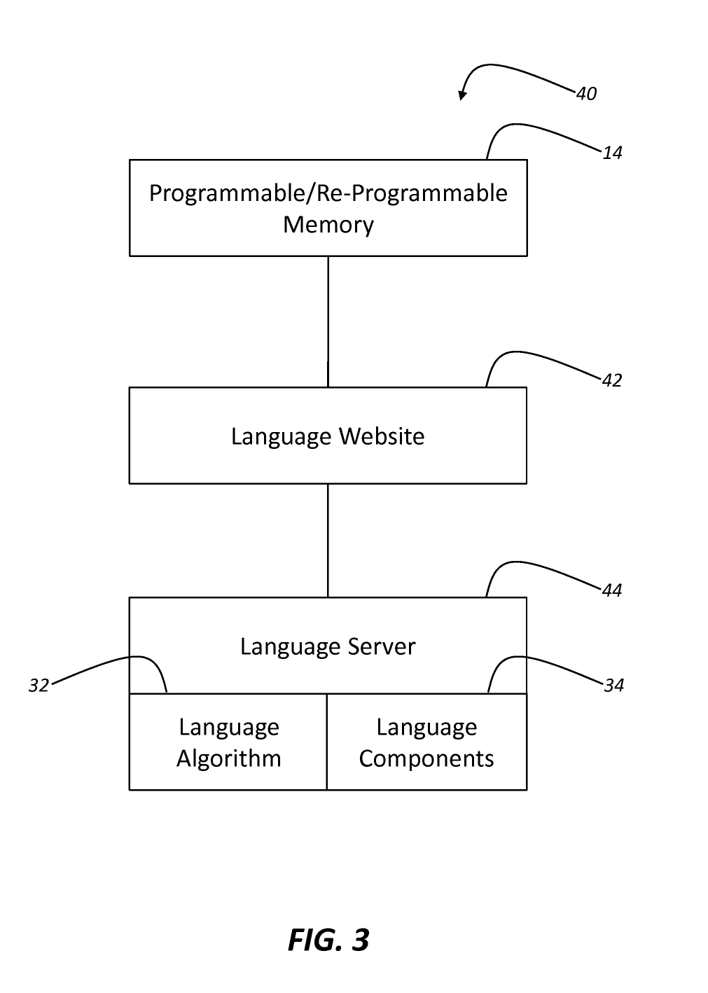

Referring now specifically to FIG. 3, in one exemplary embodiment, the language programming system 40 of the present invention includes the programmable/re-programmable memory 14 (FIG. 1) that is programmed/re-programmed by the manufacturer/user via the USB port 20 (FIG. 1) and/or the antenna/wireless interface 22 (FIG. 1) and the communicatively-coupled language website 42 coupled to the language server 44 on which the voice data 24 (FIG. 1) is stored, including the language algorithms 32 and the language components 34 associated with a plurality of different languages that can be selected and programmed by the manufacturer/user. The manufacturer/user simply goes to the language website 42, selects the language voice data 24 to be downloaded, and downloads it to the programmable/re-programmable memory 14. Again, optionally, blood glucose meter calibration and operation data can be downloaded in a similar manner to the programmable/re-programmable memory 14.

In addition to the above, the blood glucose meter 10 (FIG. 1) of the present invention further includes an external user interface utilized by the user to turn the power on/off, input personal information, set the date/time, set the mode, etc. The blood glucose meter 10 still further includes a test strip receiving unit for selectively receiving a test strip including a blood sample and analyzing the blood sample, where the blood sample is obtained from the user using a lancet device and then combined with an enzyme present on the test strip for glucose oxidase examination, for example. Optionally, the presence of the test strip in the test strip receiving unit turns the power on/off and/or otherwise activates the blood glucose meter 10. The microprocessor 12 (FIG. 1) is operable for processing the blood sample and storing the analytic results of the test strip receiving unit, and for reading and automatically calibrating the data obtained by the test strip receiving unit. The blood glucose meter 10 still further includes all electronic components required to enable and carry out the PWM scheme and/or the lie, such that an appropriate audio output is generated. The blood glucose meter 10 still further includes an external display for displaying the date/time, remaining number of test strips, blood glucose value, remaining power, etc. The blood glucose meter 10 still further includes a data transmitting module for, after use of the blood glucose meter 10, transmitting measured data to an external computer and/or computer network for storage, update, tracking, and/or analysis, where the data transmitting module can be, for example, a USB interface or an infrared emitter that transmits the measured data to the computer and/or computer network through radio frequency (RF) signals or the like. In operation, the test strip is inserted into the blood glucose meter 10, and related information is input to the microprocessor 12. The test strip receiving unit, after testing the collected blood sample, transmits measured data to the microprocessor 12, so that the measured data is stored in an appropriate memory module disposed within the blood glucose meter 10. Other components and functionalities are, of course, contemplated herein.

Although the present invention has been illustrated and described herein with reference to preferred embodiments and specific examples thereof, it will be readily apparent to those of ordinary skill in the art that other embodiments and examples may perform similar functions and/or achieve like results. All such equivalent embodiments and examples are within the spirit and scope of the present invention, are contemplated thereby, and are intended to be covered by the following claims.

What is claimed is:

1. A blood glucose meter with a simplified programmable voice function, comprising:
a microprocessor;
a memory that is both programmable and re-programmable connected to the microprocessor; and
an audio output device coupled to the microprocessor and the memory;
wherein a language algorithm and a plurality of language components specific to a language selected by a user are disposed within the memory; and
wherein the language algorithm and the plurality of language components are utilized to provide an audio output through the audio output device in the language selected or downloaded by the user.

2. The blood glucose meter of claim 1, wherein the memory comprises a flash programmable and re-programmable memory.

3. The blood glucose meter of claim 1, wherein the audio output device comprises a speaker and/or voice processing circuitry.

4. The blood glucose meter of claim 1, wherein the language algorithm is operable for determining which language components are utilized to provide the audio output and in what order based on the language selected by the user.

5. The blood glucose meter of claim 1, wherein the plurality of language components comprise a plurality of phrases, words, letters, and/or numbers in the language selected by the user.

6. The blood glucose meter of claim 1, wherein the audio output is generated by the microprocessor and the memory using a modulation scheme.

7. The blood glucose meter of claim 1, wherein the language algorithm and the plurality of language components are disposed within the memory via download from a language server via wired or wireless means.

8. The blood glucose meter of claim 7, wherein the language algorithm and the plurality of language components are disposed within the memory via download from a language server via a website and one of a universal serial bus port and a wireless link.

9. A method for providing a blood glucose meter with a simplified programmable voice function, comprising:
providing a microprocessor;
providing a memory that is both programmable and re-programmable connected to the microprocessor; and
providing an audio output device coupled to the microprocessor and the memory;
wherein a language algorithm and a plurality of language components specific to a language selected by a user are disposed within the memory; and
wherein the language algorithm and the plurality of language components are utilized to provide an audio output through the audio output device in the language selected or downloaded by the user.

10. The method for providing the blood glucose meter of claim 9, wherein the memory comprises a flash programmable and re-programmable memory.

11. The method for providing the blood glucose meter of claim 9, wherein the audio output device comprises a speaker and/or voice processing circuitry.

12. The method for providing the blood glucose meter of claim 9, wherein the language algorithm is operable for determining which language components are utilized to provide the audio output and in what order based on the language selected by the user.

13. The method for providing the blood glucose meter of claim 9, wherein the plurality of language components comprise a plurality of phrases, words, letters, and/or numbers in the language selected by the user.

14. The method for providing the blood glucose meter of claim 9, wherein the audio output is generated by the microprocessor and the memory using a modulation scheme.

15. The method for providing the blood glucose meter of claim 9, wherein the language algorithm and the plurality of language components are disposed within the memory via download from a language server via wired or wireless means.

16. The method for providing the blood glucose meter of claim 15, wherein the language algorithm and the plurality of language components are disposed within the memory via download from a language server via a website and one of a universal serial bus port and a wireless link.

17. A method for providing a blood glucose meter with a simplified programmable voice function, comprising:
providing a microprocessor;
providing a memory that is both programmable and re-programmable connected to the microprocessor; and
providing an audio output device coupled to the microprocessor and the memory;
wherein a language algorithm and a plurality of language components specific to a language selected or downloaded by a user are disposed within the memory;
wherein the language algorithm and the plurality of language components are utilized to provide an audio output through the audio output device in the language selected by the user; and
wherein the language algorithm and the plurality of language components are disposed within the memory via download from a language server via wired or wireless means.

18. The method for providing the blood glucose meter of claim 17, wherein the memory comprises a flash programmable and re-programmable memory.

19. The method for providing the blood glucose meter of claim 17, wherein the language algorithm is operable for determining which language components are utilized to provide the audio output and in what order based on the language selected by the user.

20. The method for providing the blood glucose meter of claim 17, wherein the plurality of language components comprise a plurality of phrases, words, letters, and/or numbers in the language selected by the user.

21. The method for providing the blood glucose meter of claim 17, wherein the audio output is generated by the microprocessor and the memory using a modulation scheme.

22. The method for providing the blood glucose meter of claim 17, wherein the language algorithm and the plurality of language components are disposed within the memory via download from a language server via a website and one of a universal serial bus port and a wireless link.
